(19) United States
(12) Patent Application Publication
(10) Pub. No.: US 2017/0164708 A1
(43) Pub. Date: Jun. 15, 2017

(54) TEMPERATURE CONTROL SYSTEM AND METHOD FOR HAIR STYLING APPARATUS

(71) Applicant: Spectrum Brands, Inc., Middleton, WI (US)

(72) Inventor: Michael John deGrood, Madison, WI (US)

(21) Appl. No.: 15/371,414

(22) Filed: Dec. 7, 2016

Related U.S. Application Data
(60) Provisional application No. 62/264,904, filed on Dec. 9, 2015.

(51) Int. Cl. A45D 6/20; A45D 2/00; H05B 1/02

(52) U.S. Cl. CPC A45D 6/20; H05B 1/0288; A45D 2/001; H05B 2203/03

(57) ABSTRACT

In a hair styling apparatus and method, a first arm has a heating element and a contact plate heatable by the heating element and having a hair-contact surface. At least one temperature sensor is configured to sense a temperature of the heating element. A controller is operable to determine whether the hair styling apparatus is in an opened position or a closed position and is communicatively coupled to the at least one temperature sensor. The controller is operable to control the temperature of the heating element by: when the hair styling apparatus is in its closed position, energizing the heating element when the sensed temperature falls below a first threshold temperature, and when the hair styling apparatus is in its opened position, energizing the heating element when the sensed temperature falls below a second threshold temperature. The second threshold temperature is higher than the first threshold temperature.

### CROSS-REFERENCE TO RELATED APPLICATIONS

This patent application relates to and claims priority to U.S. provisional patent application Ser. No. 62/264,904 filed Dec. 9, 2015, which is hereby incorporated by reference in its entirety.

### BACKGROUND

The present invention relates generally to a control system for a heated appliance and, more particularly, to a temperature control system for a hair straightener.

Many conventional appliances include one or more heating elements and a control system for supplying electrical current to the heating elements to energize them. For example, a hair straightener generally includes a first arm having a first heat plate and a second arm having a second heat plate energized by respective first and second heating elements. However, the temperature of the first and second heat plates may vary significantly based on whether the first and second arms are in a closed position (i.e., with the heat plates proximate one another) or in an open position (i.e., with the heat plates spaced apart from one another).

There is a need, therefore, for a control system that maintains a temperature of heat plates whether the appliance is in an open position or a closed position.

### SUMMARY

In one embodiment, a hair styling apparatus generally comprises first and second arms hingedly connected to each other for selective, pivotal movement relative to each other to configure the hair styling apparatus between an opened position and a closed position. The first arm has a heating assembly comprising a heating element and a contact plate heatable by the heating element and having a hair contact surface. At least one temperature sensor is configured to sense a temperature of the heating element. A controller is operable to determine whether the hair styling apparatus is in its opened position or its closed position and is communicatively coupled to the at least one temperature sensor. The controller is operable to control the temperature of the heating element by: when the hair styling apparatus is in its closed position, energizing the heating element when the sensed temperature falls below a first threshold temperature, and when the hair styling apparatus is in its opened position, energizing the heating element when the sensed temperature falls below a second threshold temperature. The second threshold temperature is higher than the first threshold temperature.

In another aspect, a temperature control system for a hair styling apparatus generally comprises a memory and a microcontroller communicatively coupled to the memory. The microcontroller is configured to:
receive a temperature signal from at least one temperature sensor configured to sense a temperature of a heating element;
determine whether the hair styling apparatus is in an opened position or a closed position;
when the hair styling apparatus is in its closed position, energize the heating element when the sensed temperature falls below a first threshold temperature; and
when the hair styling apparatus is in its opened position, energize the heating element when the sensed temperature falls below a second threshold temperature, wherein the second threshold temperature is higher than the first threshold temperature.

In yet another aspect, a method for controlling a hair styling apparatus generally comprises receiving, at a controller, a position signal indicating whether the hair styling apparatus is in an opened position or a closed position. At the controller, a temperature signal is received indicating a measured temperature of a heating element. When the hair styling apparatus is in its closed position, the heating element is energized when the sensed temperature falls below a first threshold temperature. When the hair styling apparatus is in its opened position, the heating element is energized when the sensed temperature falls below a second threshold temperature. The second threshold temperature is higher than the first threshold temperature.

### BRIEF DESCRIPTION

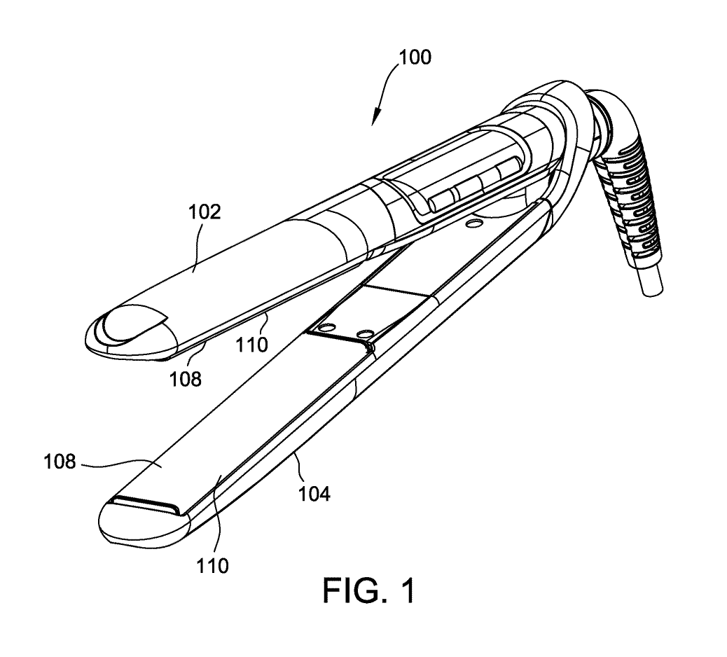

FIG. 1 is a perspective view of an embodiment of a hair straightener;

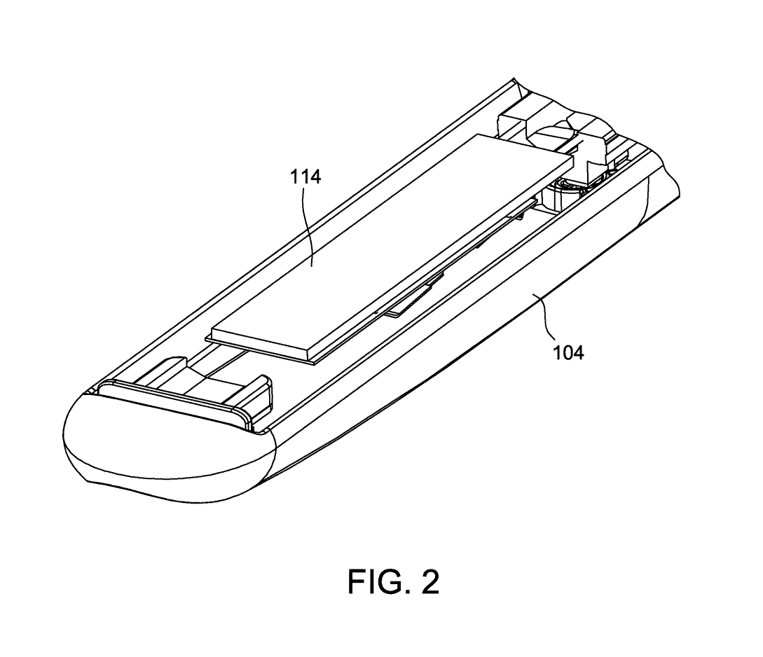

FIG. 2 is an enlarged perspective view of a portion of the straightener of FIG. 1 with a contact plate omitted to reveal internal construction;

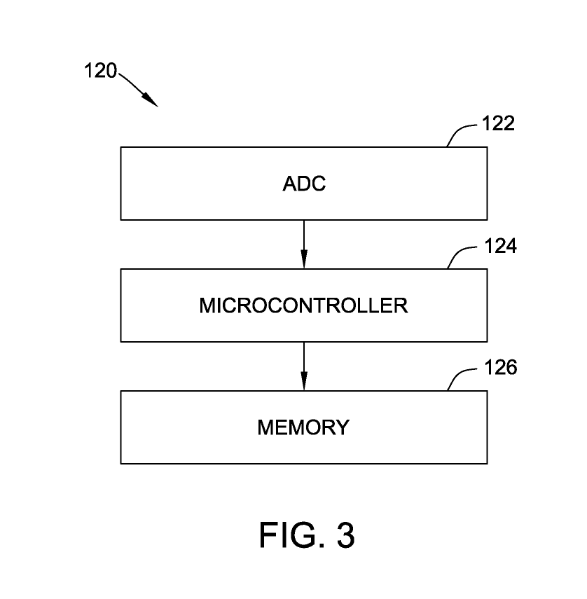

FIG. 3 is a schematic block diagram of a control system for operating the straightener of FIG. 1; and

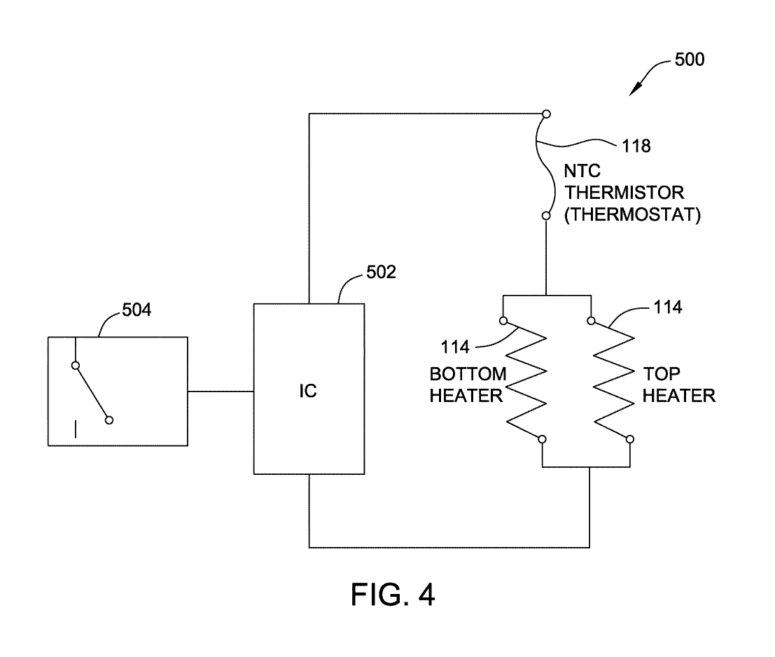

FIG. 4 is a schematic diagram illustrating an embodiment of a temperature control circuit that may be used to control the straightener of FIG. 1.

Corresponding reference characters indicate corresponding parts throughout the several views of the drawings.

### DETAILED DESCRIPTION

Referring now to the drawings, and in particular to FIGS. 1-2, a heated appliance according to one embodiment is illustrated in the form of a hair straightener and is indicated generally by the reference numeral 100. It is contemplated, however, that the embodiments described herein may be useful on other electric appliances such as, for example, hair curling irons, clothing irons, grills, toasters, toaster ovens, pizza ovens, hairdryers, coffeemakers, fish tanks, terrariums, kettles, steam mops, etc.

The illustrated hair straightener 100 comprises a pair of arms (namely, a first arm 102 and a second arm 104) that are hingedly connected together for pivoting movement relative to each other between an opened position and closed position. Each arm 102, 104 includes a heating assembly 108 comprising a hair contact plate 110 having a contact surface 112 for contacting the hair of the user and a heating element 114 housed within the arm in thermally conductive relationship with the contact plate for heating the contact plate.

The heating element housed within each arm 102, 104 is suitably connected to the power supply of the straightener 100 such that, during operation of the straightener 100, electrical current is supplied to the heating element 114 to heat the contact plate 110.

In accordance with the present invention, the heating assembly 108 associated with one or both of the arms 102, 104 may include a thermistor 118 (shown schematically in FIG. 4) for gauging the temperature of the respective heating assembly 108. For example, in one embodiment, thermistors 118 may be used to gauge the temperature of each respective heating element 114, it being understood that the temperature of the contact plates 110 and more particularly contact surfaces of the contact plates is typically lower than the temperature of the heating elements because the contact plates are exposed to air.

In accordance with one suitable embodiment, the heating assemblies 108 are controlled together (e.g., to operate at the substantially the same temperature). The thermistor 118 according to one embodiment may be a negative temperature coefficient (NTC) thermistor. Alternatively, the thermistor may be any suitable temperature monitoring device. It is also understood that any suitable temperature sensor may be used in addition to or instead of a thermistor without departing from the scope of this invention.

Referring now to FIG. 3, a control system 120 is carried by the straightener 100 and is operatively connected to each thermistor 118. In one embodiment, the control system 120 comprises an analog-to-digital converter (ADC) 122, a microcontroller 124, and a memory 126 for storing instructions to be executed by the microcontroller 124. Alternatively, the control system 120 may include any suitable processing device. The control system 120 is configured to operate the straightener 100 by controlling each heating assembly 108 during operation of the straightener 100, as described in detail herein. In the embodiments described below, the ADC 122 is a 10-bit, 5-volt device. Suitably, other ADC configurations may be used in other embodiments.

With reference now to FIG. 4, a temperature control circuit that may be used with the hair styling apparatus 100 is indicated generally at 500. The temperature control circuit 500 includes an integrated controller 502 that may be implemented, for example, using the control system 120.

As shown in FIG. 4, when used with the hair straightener 100 having hinged arms 102, 104, the integrated controller 502 is communicatively coupled to a monitoring device 504. The monitoring device 504 is operable to assess whether the straightener 100 is in a closed position (i.e., with the arms 102 and 104 and more particularly the contact plates 112 proximate one another and in some instances substantially contacting one another) or in an open position (i.e., with the arms 102 and 104 substantially spaced apart from one another). The straightener 100 is shown in a partially opened position in FIG. 1.

The monitoring device 504 may be any electro-mechanical device capable of monitoring whether the straightener 100 is in the closed position or in the open position. For example, the monitoring device 504 in accordance with one embodiment may comprise a) a Hall effect sensor (not shown) in one arm (e.g., the upper arm 102) and b) a corresponding magnet (not shown) disposed in the other arm (e.g., the lower arm 104). In one particularly suitable embodiment, the sensor and corresponding magnet are located approximately midway along each respective arm 102, 104 (e.g., between the hinge and the respective heating assembly 108). In other embodiments, a momentary push button type switch may be used to monitor the opened and closed position of the arms 102, 104. It is understood that other suitable monitoring devices may be used to monitor the opened and closed position of the arms 102, 104 without departing from the scope of this invention.

The integrated controller 502 controls a temperature of the heating elements 114 of the heating assemblies 108 based on whether the arms 102, 104 of the straightener 100 are in the closed position or in the opened position. More specifically, when the straightener 100 is in the opened position, more heat is dissipated from the contact plates 110 because the contact plates are exposed to open air. This may reduce the temperature of the contact plates 110 by approximately 10 to 20 degrees Celsius (° C.). This causes a disparity between the temperature of the contact plates 110 and the temperature of the heating elements 114.

Accordingly, although the thermistor 118 may indicate that a heating assembly 108 is operating at the same temperature in the opened position and the closed position, the actual temperature of the contact plates 110 in the open position will be substantially lower than the actual temperature of the contact plates 110 in the closed position.

For example, in at least some known straighteners, a controller may be programmed to maintain the temperature of the contact plates 110 at 230° C., whether the straightener is in a closed position or an opened position. To do so, the controller energizes the heating elements 114 whenever a thermistor 118 indicates a temperature of the heating elements 114 to be below 230° C. This results in a contact plate temperature of 230° C. when the straightener is in the closed position, but only results in a contact plate temperature of 215° C. when the straightener is in the opened position.

In contrast, in the systems and methods described herein, the integrated controller 502 controls the temperature of the heating elements 114 based on whether the straightener 100 is in the closed position or the open position (i.e., based on signals received from the hinge switch 104).

Specifically, for a predetermined temperature set point (e.g., 230° C.), when the straightener is in the closed position, the integrated controller 502 energizes the heating elements 114 in heating assemblies 108 when a temperature measured by the thermistor 118 falls below a first threshold temperature (e.g., 230° C.). However, when the straightener 100 is in the opened position, the integrated controller 502 energizes the heating elements 114 when a temperature measured by the thermistor 118 falls below a second threshold temperature (e.g., 260° C.). To account for the increased heat dissipation in the opened position, the second threshold temperature is higher than the first threshold temperature. This results in the contact plates 110 being maintained at substantially the predetermined temperature set point (e.g., 230° C.), regardless of whether the straightener is in the open position or the closed position.

It is understood that the predetermined temperature set point (Set Point) of the contact plates 110 as well as the threshold temperatures of the heating elements 114 in the opened (T₁) and closed (T₂) positions of the hair straightener 100 may be other than those set forth above. For example, in some embodiments the controller 502 may operate in accordance with any of the following.

| Set | | |
|---|---|---|
| Point | T₁ | T₂ |
| 130 | 130 | 140 |
| 140 | 140 | 152 |
| 150 | 150 | 164 |
| 160 | 160 | 176 |
| 170 | 170 | 188 |
| 180 | 180 | 200 |
| 190 | 190 | 212 |
| 200 | 200 | 224 |
| 210 | 210 | 236 |
| 220 | 220 | 248 |
| 230 | 230 | 260 |

When introducing elements of the present invention or the preferred embodiment(s) thereof, the articles “a”, “an”, “the”, and “said” are intended to mean that there are one or more of the elements. The terms “comprising,” “including”, and “having” are intended to be inclusive and mean that there may be additional elements other than the listed elements.

As various changes could be made in the above constructions without departing from the scope of the invention, it is intended that all matter contained in the above description or shown in the accompanying drawings shall be interpreted as illustrative and not in a limiting sense.

What is claimed is:

1. A hair styling apparatus comprising:
first and second arms hingedly connected to each other for selective, pivotal movement relative to each other to configure the hair styling apparatus between an opened position and a closed position, the first arm having a heating assembly comprising a heating element and a contact plate heatable by the heating element and having a hair-contact surface,
at least one temperature sensor configured to sense a temperature of the heating element; and
a controller operable to determine whether the hair styling apparatus is in its opened position or its closed position and being communicatively coupled to the at least one temperature sensor, the controller being operable to control the temperature of the heating element by:
when the hair styling apparatus is in its closed position, energizing the heating element when the sensed temperature falls below a first threshold temperature; and
when the hair styling apparatus is in its opened position, energizing the heating element when the sensed temperature falls below a second threshold temperature, wherein the second threshold temperature is higher than the first threshold temperature.

2. The hair styling apparatus of claim 1 wherein the second threshold temperature is at least 10° C. higher than the first threshold temperature.

3. The hair styling apparatus of claim 1 wherein the controller is configured to control the temperature of the heating element such that the contact plate is generally maintained at a predetermined target temperature in both the opened position and the closed position of the hair styling apparatus.

4. The hair styling apparatus of claim 3 wherein the predetermined target temperature of the heat plate is approximately 230° C., the first threshold temperature is approximately 230° C. and the second threshold temperature is approximately 260° C.

5. The hair styling apparatus of claim 1 wherein the at least one temperature sensor comprises a thermistor.

6. The hair styling apparatus of claim 1 wherein the at least one temperature sensor comprises a negative temperature coefficient thermistor.

7. The hair styling apparatus of claim 1 wherein the controller has a monitoring device operable to monitor movement of the arms between the opened and closed positions of the hair styling apparatus.

8. The hair styling apparatus of claim 1 wherein the second arm has a respective heating assembly comprising a heating element and a contact plate heatable by the heating element and having a hair-contact surface, and at least one temperature sensor configured to sense a temperature of the heating element of the second arm, the controller being operable to control operation of both the heating element of the first arm and the heating element of the second arm.

9. A temperature control system for a hair styling apparatus having first and second arms hingedly connected to each other for selective, pivotal movement relative to each other to configure the hair styling apparatus between an opened position and a closed position, the first arm having a heating assembly including a heating element and a contact plate heatable by the heating element and having a hair-contact surface, the control system comprising:
a memory; and
a microcontroller communicatively coupled to the memory and configured to:
receive a temperature signal from at least one temperature sensor configured to sense a temperature of the heating element;
determine whether the hair styling apparatus is in its opened position or its closed position;
when the hair styling apparatus is in its closed position, energize the heating element when the sensed temperature falls below a first threshold temperature; and
when the hair styling apparatus is in its opened position, energize the heating element when the sensed temperature falls below a second threshold temperature, wherein the second threshold temperature is higher than the first threshold temperature.

10. The temperature control system of claim 9 wherein the microcontroller is further configured to receive a position signal from a monitoring device, the position signal indicating whether the hair styling apparatus is in its opened position or its closed position.

11. The temperature control system of claim 9 wherein the second threshold temperature is at least 10° C. higher than the first threshold temperature.

12. The temperature control system of claim 9 wherein the microcontroller is configured to control the temperature of the heating element such that the contact plate is generally maintained at a predetermined target temperature in both the opened position and the closed position of the hair styling apparatus.

13. The temperature control system of claim 12 wherein the predetermined target temperature of the contact plate is approximately 230° C., the first threshold temperature is approximately 230° C. and the second threshold temperature is approximately 260° C.

14. The temperature control system of claim 9 wherein the second arm has a respective heating assembly including a heating element and a contact plate heatable by the heating element and having a hair-contact surface, the controller being operable to control operation of both the heating element of the first arm and the heating element of the second arm.

15. A method for controlling a hair styling apparatus having first and second arms hingedly connected to each other for selective, pivotal movement relative to each other to configure the hair styling apparatus between an opened position and a closed position, the first arm having a heating assembly including a heating element and a contact plate heatable by the heating element and having a hair-contact surface, the method comprising:
receiving, at a controller, a position signal indicating whether the hair styling apparatus is in its opened position or its closed position;
receiving, at the controller, a temperature signal indicating a measured temperature of the heating element;
when the hair styling apparatus is in its closed position, energizing the heating element when the sensed temperature falls below a first threshold temperature; and
when the hair styling apparatus is in its opened position, energizing the heating element when the sensed temperature falls below a second threshold temperature, wherein the second threshold temperature is higher than the first threshold temperature.

16. The method of claim 15 wherein receiving a position signal comprises receiving a position signal from a hinge switch.

17. The method of claim 15 wherein the second arm has a respective heating assembly including a heating element and a contact plate heatable by the heating element and having a hair-contact surface, and at least one temperature sensor configured to sense a temperature of the heating element of the second arm, and wherein receiving a temperature signal comprises receiving a temperature signal from a thermistor on each arm of the heated appliance.

18. The method of claim 15 wherein receiving a temperature signal comprises receiving a temperature signal from a single thermistor.

19. The method of claim 15 wherein energizing the heating element when the measured temperature falls below a first threshold temperature comprises energizing the heating element when the measured temperature falls below approximately 230° C.

20. The method of claim 15 wherein energizing the heating element when the measured temperature falls below a second threshold temperature comprises energizing the heating element when the measured temperature falls below approximately 260° C.
